(19) United States
(12) Patent Application Publication
(10) Pub. No.: US 2007/0276626 A1
(43) Pub. Date: Nov. 29, 2007

(54) System and apparatus for remote monitoring of conditions in locations undergoing water damage restoration

(76) Inventor: Timothy Neil Bruffey, Martinsburg, WV (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/725,170

(22) Filed: Mar. 16, 2007

Related U.S. Application Data
(60) Provisional application No. 60/782,902, filed on Mar. 16, 2006.

(51) Int. Cl. G06F 17/00

(52) U.S. Cl. 702/182; 340/602; 340/604

(57) ABSTRACT

A system for monitoring environmental conditions at a facility which has suffered water damage which includes one or more sensors or sensor nodes adapted in certain embodiments to measure environmental conditions and to transmit or communicate information or data relating to such environmental conditions through a wireless transmitter. In certain aspects, the monitoring system comprises a wireless mesh network having a mesh router, a plurality of sensor nodes and a remote operating unit adapted to receive such environmental condition information.

### PRIORITY CLAIM

The present application claims priority to U.S. Provisional Patent Application No. 60/782,902, filed Mar. 16, 2006.

### TECHNICAL FIELD

The present invention relates to a system for remotely monitoring moisture, humidity, temperature, and other conditions within a building or structure undergoing water mitigation treatment.

### BACKGROUND OF THE INVENTION

The process of water damage restoration requires accurate and routine monitoring to produce optimal results. Technicians in the water mitigation industry must inspect sites daily to insure that the appropriate drying equipment is installed and working correctly and to determine whether the structure is drying properly. Such monitoring becomes problematic in commercial structures when technician entry is limited on weekends or holidays. Similarly, if the damaged structure is a private dwelling, residents may not feel comfortable allowing a technician necessary access if the home is unoccupied.

Systems for monitoring environmental conditions in a remote location are known in the prior art. However, most systems are permanently installed or designed for use in only one location, and none provide a valuable analysis of incoming data specific to the water mitigation business or industry.

U.S. Pat. No. 6,437,692 and U.S. Pat. No. 5,719,563 teach systems for monitoring various conditions within a remotely located region. These systems, however, are designed for permanent installation and are permanently connected to a wide area network. Likewise, U.S. Pat. No. 3,744,043 discloses an environmental data system which is hard wired to a communication network, i.e. permanent not portable.

Individuals and companies in the water damage restoration business could perform more effectively and efficiently with a system to remotely monitor drying status, and other conditions in a building or structure damaged by water. The system should be portable so it can be redeployed at subsequent sites, among other things. Ideally, the system should collect and analyze sensor data instead of merely transmitting data, as seen in prior art systems. In addition, a system that performs periodic or real-time monitoring of each location would amass a more reliable data set than a technician with daily reporting.

There is a need, therefore, for an improved system for remote monitoring of homes, commercial buildings and other structures undergoing treatment and cleanup for flood or other water-related damage.

### BRIEF SUMMARY OF THE INVENTION

With parenthetical reference to the corresponding parts, portions or surfaces of the disclosed embodiment, merely for purposes of illustration and not by way of limitation, the present invention provides an improved system for remote monitoring of homes, commercial buildings and other structures (18) undergoing treatment and cleanup for flood or other water-related damage, comprising a site monitoring apparatus (15) and a remote operating unit (16). In one aspect, the site monitoring apparatus comprises a sensor or sensors (22) with a wireless transmitter and a central processor or processing unit (19). In certain aspects, the sensor or sensors (22) detect(s) one or more environmental conditions and relay(s) environmental condition information through the wireless transmitter to the central processor (19) equipped with a wireless receiver (21). The central processor in turn relays the information to a remote operating unit (16) through a modem (20) in one aspect of the invention. In other aspects, the sensor(s) or sensor node(s) are part of and/or communicate through a mesh network (which, in one embodiment, is a wireless mesh network) in which a mesh router communicates information to a remote operating unit. In other embodiments, alternate wireless technologies, such as Bluetooth, are used to communicate between the component parts of the system. In one aspect, the remote operating unit (16) can receive information from multiple sites undergoing water damage mitigation. In another aspect of the invention, clients and restoration professionals can access the information from a remote site or remote operating unit via the internet, thereby monitoring drying activity and other conditions at multiple sites in real-time, without dispatching technicians. In other aspects, the system or apparatus is configured to communicate alerts to the remote operating unit via internet, e-mail, cell phone or pager when a pre-selected environmental condition is measured. In another aspect, the remote operating unit is configured to generate insurance forms relative to said water damage.

The general object of the invention is to provide an improved water damage mitigation monitoring system. Another object is to provide an improved water damage mitigation monitoring system with components that can be temporarily installed in a structure undergoing water damage mitigation.

Another object of the invention is to provide improved water damage mitigation monitoring system that records accurate multi-point readings from various locations within one structure undergoing water damage mitigation. Yet another object is to provide an improved water damage mitigation monitoring system that simultaneously monitors air outside the structure, unaffected air inside the structure, dehumidifier output air, and other affected points inside the structure.

A further object of the invention is to provide an improved water damage mitigation monitoring system that monitors a structure in real time. Another object is to provide an improved water damage mitigation monitoring system that allows clients to access environmental condition information via the internet, 24 hours a day, 7 days a week, from any internet connected device such as a computer, laptop, or internet-enabled PDA. Another object is to provide an improved water damage mitigation monitoring system that delivers automatic alerts via email, telephone, cell phone and/or pager to notify customers that equipment has stopped, equipment has malfunctioned, or drying or other goals have been met. Another object is to provide an improved water damage mitigation monitoring system that automatically completes insurance forms.

These and other objects and advantages will become apparent from the foregoing and ongoing written specification, and the accompanying drawings.

### BRIEF DESCRIPTION OF THE DRAWINGS

FIG. 1 is a schematic diagram of the water damage mitigation monitoring system.

FIG. 2 is a flowchart of a server listener service in one embodiment of the invention.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

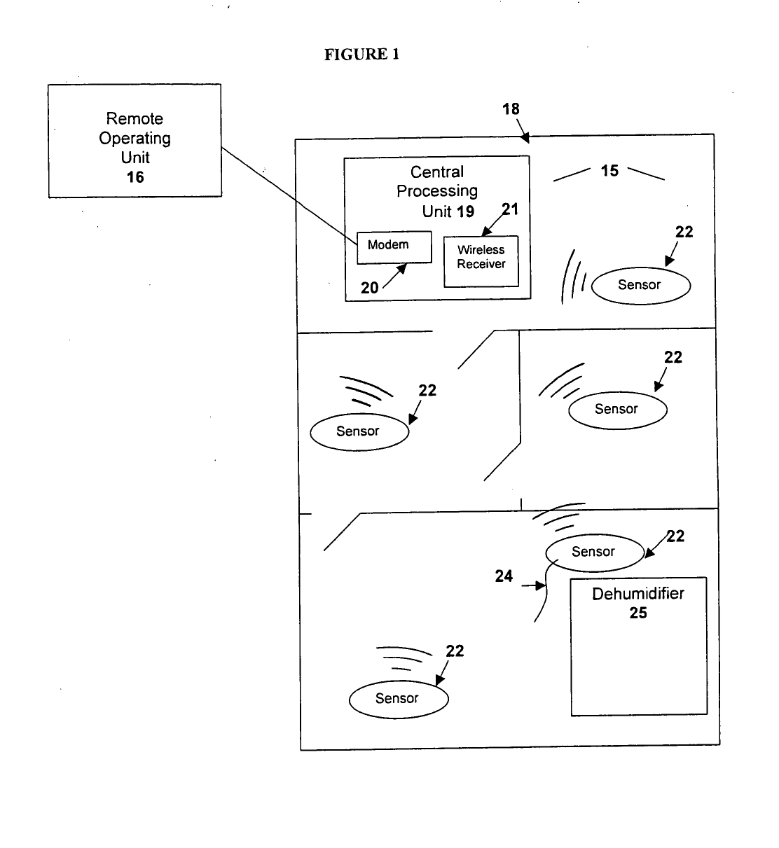

Referring now to the drawings, and, more particularly, to FIG. 1 thereof, the present invention provides a water damage mitigation monitoring system comprising a site monitoring apparatus 15 for installation in a structure 18 undergoing water mitigation treatment, and a remote operating unit 16. In one embodiment, the site monitoring apparatus 15 comprises sensors, severally indicated at 22 and a central processor or processing unit 19. The sensors measure one or more environmental conditions such as moisture level, temperature and humidity. The sensors 22 in one embodiment, are equipped with wireless transmitters and transmit environmental condition information through the wireless to a central processor 19 equipped with a wireless receiver 21. In this embodiment, the central processor 19 receives the environmental condition information and proceeds to transmit that information through a modem 20 to a remote operating unit 16. In another embodiment, sensor nodes 22 communicate wirelessly with a mesh router which in turn communicates with a remote operating unit 16. The remote operating unit 16 proceeds to store the incoming data, which is then available for client and restoration professional access.

In one embodiment, the present invention can monitor several locations at once. Each structure 18 undergoing water mitigation treatment is outfitted with a sensor or sensors 22, and a processor 19, and all such processors communicate with one remote operating unit 16.

In one embodiment, sensors 22 are temporarily installed in the structure 18 undergoing water mitigation treatment. The sensors detect various environmental conditions such as temperature and humidity and relay the resultant information to central processor 19 through wireless transmitter. As illustrated in FIG. 1, this embodiment utilizes more than one sensor 22, and each sensor 22 may measure a different environmental condition. The system may monitor air outside the structure, unaffected air inside the structure, dehumidifier output air and/or other affected points in the structure.

Sensors and sensor nodes 22 carry out a networking function because they communicate wirelessly from various points within the structure 18 back to a centrally located processor 19 and/or mesh router. In a preferred embodiment, each sensor node 22 is part of a mesh wireless network, but it is contemplated that other wireless networks, such as Bluetooth and others, may be used as alternatives. Each sensor or sensor node 22 may be mounted on a wall, baseboard, dehumidifier or other drying equipment 25, or placed on the floor. Sensors and sensor nodes 22 may have probes or tethers 24, for example. The EMS100, manufactured by B&B Electronics Manufacturing Company, is one example of a sensor that measures temperature and humidity. B&B also produces the MM100, a 2-channel sensor that measures moisture, which may be used as part of the invention described herein. It is contemplated that other sensors with wireless communication capability, and sensors equipped with a wireless communication device could be used as alternatives.

A mesh network (also sometimes referred to as a “multi-hop” network), as described above, provides for transmitting, routing or otherwise communicating data and information between nodes. Mesh nodes are typically line powered devices and remain in a receive or “listening” mode, reducing latency throughout the network. Multiple mesh nodes may be utilized in line to “multi-hop” messages through a mesh network. One advantage of a mesh network is that such data and information may be communicated even if one or more nodes is inoperable, improving reliability. Another advantage is that various components of a mesh network can connect or communicate with each other via multiple hops between various combinations of nodes. As known to those skilled in the art, mesh networks use mesh routers to continuously monitor network activity and receive and maintain data or other information relative to all sensor nodes and/or other devices in a network, and automatically adjust to the addition and subtraction of network components. Mesh routers may be dedicated devices or may be laptop computers, for example, configured or programmed to act as a network router. In other words, mesh routers are intelligent routing modules that may serve to “multi-hop” messages in and through a mesh network, e.g. to receive environmental condition information from sensor nodes and to communicate with a remote operating unit. Mesh routers may receive incoming messages and attempt send them to a gateway (or to other mesh routers), leveraging multiple possible routes to ensure system reliability.

A mesh router is an intelligent repeater that optimizes and extends the operating range of a wireless sensor. In one embodiment of the invention, a mesh router establishes direct communication links with two other mesh routers or gateways in the mesh network. This redundancy ensures that a wireless message coming from or going to a wireless sensor or another mesh router will be received. The use of mesh routers also minimizes the latency and maximizes the scalability within a mesh network of the present invention. The flexible and redundant nature of mesh networks also increases fault tolerance. Mesh routers require a low-voltage DC power input that can be achieved through an AC power transformer or a directly connected low-voltage DC power line. In one embodiment, such routers include a battery back-up capability to ensure continuous network operations in the event of a power failure.

In one embodiment of the invention, the mesh network is established or created by simply turning on all of the devices or components in the system. In this case, a mesh router automatically recognizes the components of the network. In this embodiment, every device supports bi-directional communication, assuring that transmitted messages are acknowledged by the intended receiver (in the case of a transmitting wireless sensor, the intended receiver would be either a mesh router or a gateway). If no acknowledgement is received, the message will be re-transmitted to a redundant, secondary receiver. In a preferred embodiment, if new wireless sensors or mesh routers are added to or removed from the network, the mesh network automatically reconfigures the network in real-time, permitting the node access if it has authorization.

In a preferred embodiment, the mesh network is a wireless mesh network. In this embodiment, wireless sensor nodes, also known as end points or star nodes, may be battery-operable and last for many years. In one embodiment of the invention, wireless sensor nodes spend most of their time in a deep sleep mode, conserving energy, and then awake to either receive messages or transmit sensing or status information. These devices can either communicate directly with the gateway, or if added range or redundancy is required by the application, they can communicate with a routing device.

In one embodiment, the central processor or processing unit 19 is a Linux-embedded computer equipped with a bridge or wireless receiver 21 and a modem 20. It is contemplated that the processor 19 can function on other operating systems, such as Windows. In this embodiment, the central processor 19 logs data from the sensors, severally indicated at 22, communicates with a remote operating unit 16, and transfers data. The bridge or wireless receiver 21 is hardware for interfacing to the processor 19 to allow communication with sensors, severally indicated at 22.

In one embodiment, a central processor 19 is the key communication element between the wireless sensor network and remote operating unit 16. The processor 19 stores all of the required data from the wireless sensor 22 system and communicates this data to a remote operating unit 16 via a modem 20 or other connection. The processor 19 provides the interface between the wireless network within a structure 18 and the remote operating unit 16. In another embodiment, a mesh router is the key communication element between the wireless sensor network and remote operating unit 16.

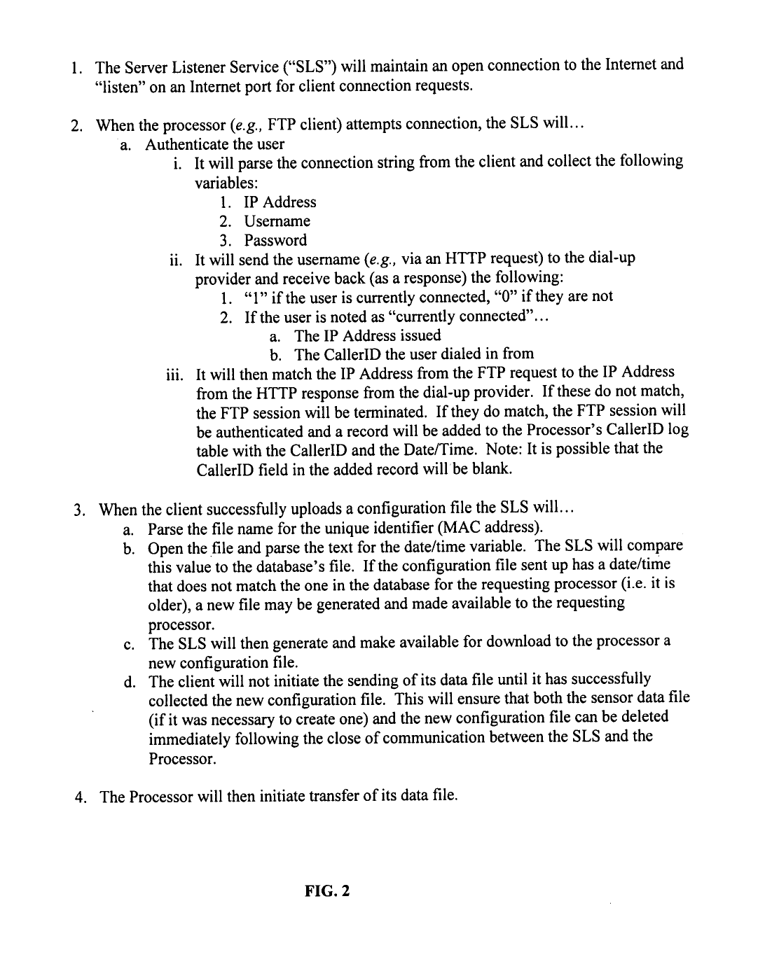

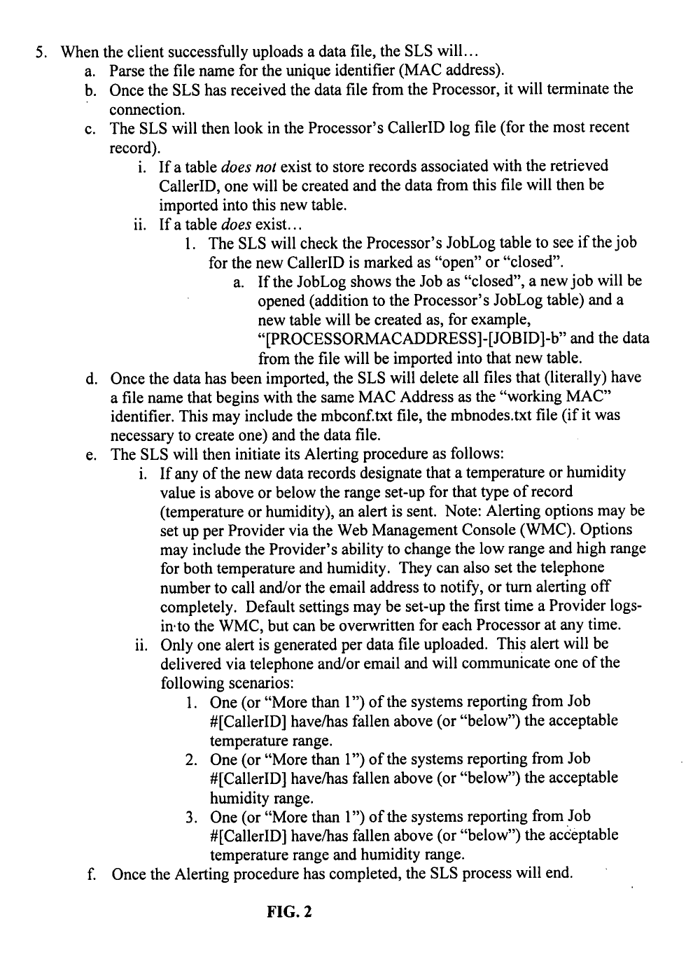

In one embodiment of the present invention, the remote unit 16 will receive and store incoming data from multiple central processors 19 or mesh routers. This data transfer from each processor 19 may be accomplished in one aspect of the invention by a Server Listening Service (SLS) but it is contemplated that any data transfer technique could be used as an alternative. An illustration of the operation of SLS is shown in FIG. 2.

In addition to storing all data from all central processors 19, the remote operating unit 16 has the capability to store data from clients, alert data, and billing data. The remote operating unit 16 allows client access via the internet or telephone lines, whereby clients can manage their alerting options and view data from processors 19 located in structures in which they provide water damage mitigation treatment.

In one embodiment of the invention, a client utilizing the water damage mitigation system will have access to a website that will display pertinent data received from each location. By entering a username and password, the client can view site-specific information such as moisture level, humidity, temperature, and other environmental conditions to determine, among other things, if the selected equipment is sufficient and functional. In addition, this embodiment will provide automatic alerts via email, telephone, cell phone, and pager, to notify a customer that equipment has stopped, equipment has malfunctioned, or drying goals have been met. Clients that know precisely when drying goals are met can reallocate resources and make more efficient use of time and equipment among other things.

While there has been described what is believed to be the preferred embodiment of the present invention, those skilled in the art will recognize that other and further changes and modifications may be made thereto without departing from the spirit of the invention. Therefore, the invention is not limited to the specific details and representative embodiments shown and described herein. The terminology and phraseology used herein is for purposes of description and should not be regarded as limiting. Accordingly, persons skilled in this art will readily appreciate that various additional changes and modifications may be made without departing from the spirit or scope of the invention.

What is claimed is:

1. A mesh network system for real-time monitoring of environmental conditions relative to water damage, comprising:
a site monitoring apparatus having at least one sensor node for measuring at least one environmental condition; and at least one mesh router for receiving said environmental condition from said sensor node; and
a remote operating unit enabling communication of said environmental condition to a user and allowing said user to communicate with said site monitoring apparatus, wherein said mesh router communicates said environmental condition to said remote operating unit.

2. The system of claim 1, comprising a plurality of sensor nodes, wherein said mesh router coordinates communication between each of said sensor nodes and said remote operating unit.

3. The system of claim wherein said environmental condition is temperature, humidity or moisture level.

4. The system of claim 1 wherein said remote operating unit is a laptop computer, internet-enabled workstation, mobile phone, pager, PDA or ASP server.

5. The system of claim 1 wherein said remote operating unit is configured to communicate an alert to said user via internet, e-mail, cell phone or pager when a pre-selected environmental condition is measured.

6. The system of claim 1 wherein said remote operating unit is configured to generate insurance forms relative to said environmental condition.

7. An apparatus for monitoring environmental conditions at a site which has suffered water damage, comprising:
a first site monitoring apparatus having at least one wireless sensor for measuring at least one environmental condition; a wireless transmitter associated with said wireless sensors for transmission of said environmental condition; and a processing unit having a wireless receiver for reception of said environmental condition from said wireless transmitter; and
a remote operating unit enabling communication of said environmental condition to a user through a modem and allowing said user to communicate with said site monitoring apparatus, wherein said processing unit communicates said environmental condition to said remote operating unit.

8. The apparatus of claim 7, further comprising:
a second site monitoring apparatus having at least one wireless sensor for measuring at least one environmental condition; a wireless transmitter associated with said wireless sensors for transmission of said environmental condition; and a processing unit having a wireless receiver for reception of said environmental condition from said wireless transmitter;
wherein said remote operating unit enables communication to a user of said environmental condition associated with said first site monitoring apparatus and said environmental condition associated with said second site monitoring apparatus.

9. The apparatus of claim 7 wherein said environmental condition is temperature, humidity or moisture level.

10. The apparatus of claim 7 wherein said remote operating unit is a laptop computer, internet-enabled workstation, mobile phone, pager, PDA or ASP server.

11. The apparatus of claim 7 wherein said wireless sensor transmits a Bluetooth signal or wifi signal.

12. The apparatus of claim 7 wherein said remote operating unit is configured to communicate an alert to said user via internet, e-mail, cell phone or pager when a pre-selected environmental condition is measured.

13. The apparatus of claim 7 wherein said remote operating unit is configured to generate insurance forms relative to said water damage.

14. The apparatus of claim 7 wherein said processing unit communicates with said remote operating unit via a server listening service.

15. The apparatus of claim 7 wherein said processing unit comprises a Linux-embedded computer; and a bridge or a wireless receiver.
